(19) United States
(12) Patent Application Publication
(10) Pub. No.: US 2017/0203806 A1
(43) Pub. Date: Jul. 20, 2017

(54) FUEL SUPPLY METHOD OF MOTORCYCLE ENGINE

(71) Applicant: NATIONAL TAIPEI UNIVERSITY of TECHNOLOGY, Taipei City (TW)

(72) Inventors: Yuh-Yih WU, Taipei City (TW); Chia-Hong CHUNG, Taipei City (TW); Yung-Hsiang HSU, Taipei City (TW); Huang-Min LIN, Taipei City (TW); Yong-Fu SYU, Taipei City (TW); Han-Ying WANG, HsinChu (TW)

(21) Appl. No.: 15/155,066

(22) Filed: May 15, 2016

(30) Foreign Application Priority Data
Jan. 18, 2016 (TW) 105101386

(51) Int. Cl. B62J 37/00; F02M 61/16; F02M 37/22; F02M 37/00

(52) U.S. Cl. CPC B62J 37/00; F02M 37/0064; F02M 37/007; F02M 37/0017; F02M 61/16; F02M 37/223; F02M 37/0029

(57) ABSTRACT

The present disclosure provides a method of supplying fuel for a motorcycle engine. The method includes the following steps. A tank, a pipe and an injector are provided, and the pipe is connected between the tank and the injector. Fuel in the tank is transported to the injector through the pipe, and a pressure of the fuel in the pipe is in a range larger than 2.5 and smaller than or equal to 4.0 kg/cm².

### REFERENCE TO RELATED APPLICATION

This application claims priority to Taiwan Application Serial Number 105101386, filed Jan. 18, 2016, which is herein incorporated by reference.

### BACKGROUND OF THE INVENTION

Field of the Invention

The present invention relates to a method of injecting a fuel, and in particular to a method of injecting a fuel into a motorcycle engine.

The Prior Art

The exhaust emitted by the combustion of motorcycle engine is one of the main reasons of air pollution. With increasingly stringent pollution regulations and energy crisis caused by rapid consumption of gasoline, it is urgent to develop environmental alternatives replacing gasoline. The general alternatives include battery electric vehicle (BEV) hybrid electric vehicle (HEV), and alternative fuel. However, battery electric vehicle (BEV) and hybrid electric vehicle (HEV) still have problem related to battery technology. Therefore, alternative fuel is still an ideal alternative in the short term.

Although a variety of fuels such as liquefied petroleum (LPG), dimethyl ether (DME) and ethanol are currently used in an engine test, they have problems of environmental pollution and loss of food. For example, ethanol is erosive and easily dissolved in water. Therefore, existing fuel can not able to be used in pipe transportation. Moreover, manufacturing ethanol from crops easily causes the problem of robbing food with people.

Therefore, it is essential for an environmental alternative fuel and a method of supplying fuel, which can be practically used in the motorcycle engine.

### SUMMARY OF THE INVENTION

In view of the issue met in the art, the present disclosure provides a method of supplying fuel for a motorcycle engine, and the method includes the following steps. A tank, a pipe and an injector are provided, and the pipe is connected between the tank and the injector. Fuel in the tank is transported to the injector through the pipe, and a pressure of the fuel in the pipe is in a range large than 2.5 to 4.0 kg/cm².

In various embodiments of the present disclosure, the pressure of the fuel in the pipe is controlled by a pressure regulator disposed between the rank and the pipe.

In various embodiments of the present disclosure, the pressure of the fuel in the pipe is 3.5 kg/cm².

In various embodiments of the present disclosure, the fuel is butanol or mixed oil including butanol and gasoline.

In various embodiments of the present disclosure, the gasoline including octane number 95 unleaded gasoline.

In various embodiments of the present disclosure, the percentage concentration by volume of the butanol in the mixed oil is in a range of 60˜99%.

In various embodiments of the present disclosure, the percentage concentration by volume of the butanol in the mixed oil is in a range of 60˜80%.

In various embodiments of the present disclosure, the percentage concentration by volume of the butanol in the mixed oil is 60%, and the percentage concentration by volume of the gasoline in the mixed oil is 40%.

In various embodiments of the present disclosure, the percentage concentration by volume of the butanol in the mixed oil is 80%, and the percentage concentration by volume of the gasoline in the mixed oil is 20%.

In various embodiments of the present disclosure, the method further includes a following step. A heat treatment is performed to the fuel in the pipe, so that a temperature of the fuel is in a range of 50˜90° C.

In various embodiments of the present disclosure, during the step of performing the heat treatment to the fuel in the pipe, the temperature of the fuel is controlled by a heater disposed between the pipe and the injector.

In various embodiments of the present disclosure, the temperature of the fuel is in a range of 70˜90° C.

The present disclosure provides the method of supplying fuel for the motorcycle engine. The method is environment-friendly and able to fully spray the fuel, so that the fuel is evenly blended with air to produce a rapid and complete combustion reaction.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a data diagram illustrating the viscosity of the fuel according to some embodiments of the present disclosure.

FIG. 2 is a data diagram illustrating the viscosity of the fuel according to some embodiments of the present disclosure.

FIG. 3 is a schematic diagram illustrating a partial structure of the fuel applying system according to some embodiments of the present disclosure.

FIGS. 4A˜4C are photographs showing the spraying state of the fuel according to some embodiments of the present disclosure.

FIG. 5 is a schematic diagram illustrating a partial structure of the fuel applying system according to some embodiments of the present disclosure.

FIG. 6 is a data diagram illustrating the brake specific fuel consumption (BSFC) of an engine according to some embodiments of the present disclosure.

FIGS. 7A and 7B are data diagrams illustrating the amount of carbon monoxide (CO) and hydrocarbon (HC) produced by fuel combustion according to some embodiments of the present disclosure.

FIG. 8 is a data diagram illustrating the coefficient of variation of indicated mean effective pressure (COV of IMEP) of an engine according to some embodiments of the present disclosure.

FIGS. 9A and 9B are data diagrams illustrating cylinder pressure of an engine according to some embodiments of the present disclosure.

FIGS. 10A and 10B are data diagrams illustrating the mass burning rate of the fuel in the engine according to some embodiments of the present disclosure.

FIG. 11 is a schematic diagram illustrating a partial structure of the fuel applying system according to some embodiments of the present disclosure.

### DETAILED DESCRIPTION OF THE PREFERRED EMBODIMENT

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

As stated above, it can be seen that the fuel used currently have some disadvantages such as problems of environmental pollution and loss of food. Therefore, the present disclosure provides a method of supplying fuel for a motorcycle engine, which is environment-friendly, do not affect the food supply and enables complete combustion of fuel.

The present disclosure provides a method of supplying fuel for a motorcycle engine, and the method includes the following steps. A tank, a pipe and an injector are provided, and the pipe is connected between the tank and the injector. Fuel in the tank is transported to the injector through the pipe, and a pressure of the fuel in the pipe is in a range large than 2.5 to 4.0 kg/cm², preferably 3.5 kg/cm².

In some embodiments, the present disclosure use butanol or mixed oil including butanol and gasoline as fuel. In accordance with some embodiments, the gasoline in the mixed oil is octane number 95 unleaded gasoline.

The resource of butanol used in the present disclosure is from cellulose, which can be extracted from non-grain fuel such as straw, plant fibers and other agricultural wastes. Also, butanol may directly function as gasoline additives. Accordingly, butanol as a fuel does not consume food resources.

In accordance with some embodiments, the percentage concentration by volume of the butanol in the mixed oil is in a range of 60˜99%, preferably 60˜80%. Specifically, the percentage concentration by volume of the butanol in the mixed oil is 60%, and the percentage concentration by volume of the gasoline in the mixed oil is 40%. Alternatively, the percentage concentration by volume of the butanol in the mixed oil is 80%, and the percentage concentration by volume of the gasoline in the mixed oil is 20%.

In the following embodiments, fuel used hereafter is butanol (hereinafter referred as B100), mixed oil consisting of butanol in the percentage concentration by volume of 80% and gasoline in the percentage concentration by volume of 20% (hereinafter referred as B80), or another mixed oil consisting of butanol in the percentage concentration by volume of 60% and gasoline in the percentage concentration by volume of 40% (hereinafter referred as B60).

Since the fuel including butanol has high viscosity, it is not easy to evenly blend with air. Hence, it causes the problem of incomplete combustion. In order to develop improvement plans, the viscosity test of alternative fuel such as B100, B80 and B60 compared with gasoline is performed first.

The viscosity test of the present disclosure is based on a viscosity test equipment, SV-10 viscometer (A&D Company Ltd). B100, B80, B60 and gasoline are poured into the test plate first, and followed by measuring the viscosity thereof under different concentration and temperature. The measured values that can be monitored by the viscometer, and the unit of the measured values is absolute viscosity (cp), or called dynamic viscosity.

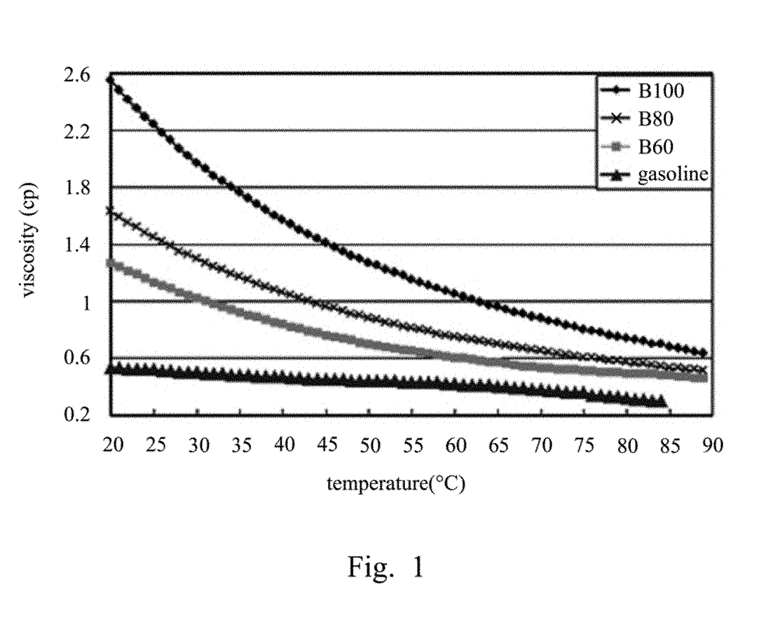

The result of the viscosity test as shown in FIG. 1 can be seen that the viscosity of B100, B80 and B60 are higher than that of gasoline under the test temperature, and the viscosity of B100 is the highest. It should be noted that the viscosity of B100, B80 and B60 decrease with increasing temperature.

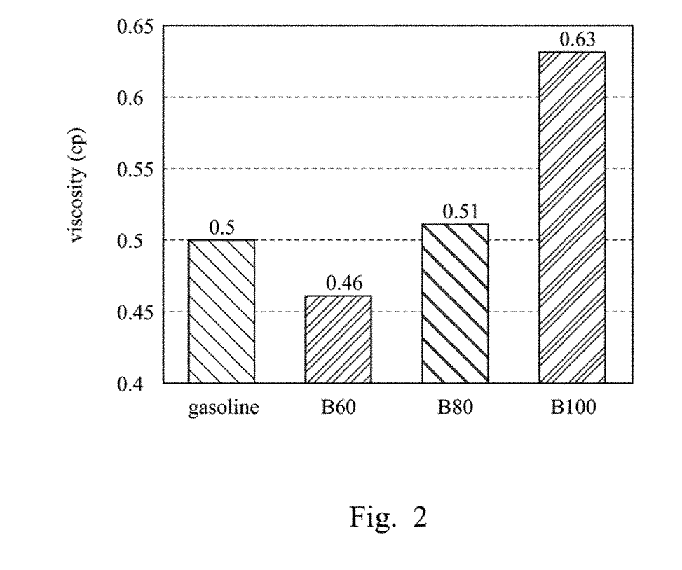

From the above viscosity test, the viscosity of B100 B80 and B60 can be altered by temperature, and it decreases with increasing temperature. The viscosity of the gasoline at room temperature (30° C.) and that of the B100, B80, and B60 at 89° C. are compared in the following, which is illustrated in FIG. 2. The results show that the viscosity of B100, B80, and B60 at 89° C. is close to the viscosity of gasoline at room temperature (30° C.), and the decreasing viscosity is able to increase spraying degree of fuel so that the problem of incomplete combustion of fuel can be improved.

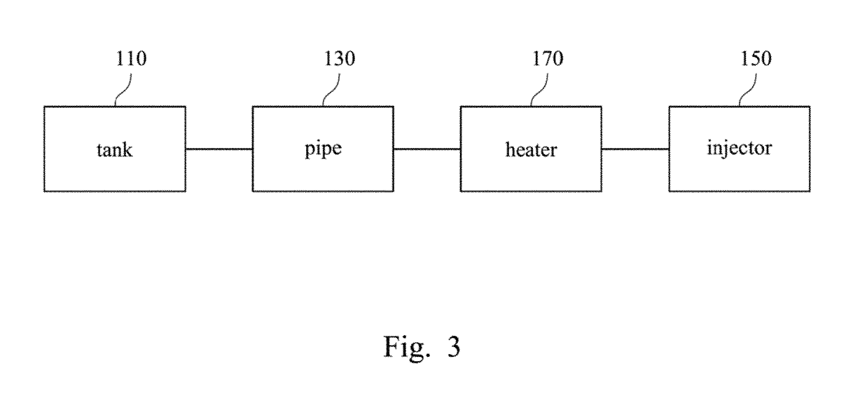

Please refer to FIG. 3. FIG. 3 is a schematic diagram illustrating a partial structure of the fuel applying system according to some embodiments of the present disclosure.

Therefore, in order to increase the spraying degree so as to improve the problem of the incomplete combustion. In accordance with some embodiments, the method of applying fuel provided by the present disclosure further includes, other than providing a tank 110, an injector 150 and a pipe 130 between the tank 110 and the injector 150, providing a heater 170 between the pipe 130 and the injector 150. The heater 170 may perform a heat treatment to the fuel in the pipe 130 so that the temperature of the fuel is in a range of 50° C. to 90° C., preferably in a range of 70° C. to 90° C.

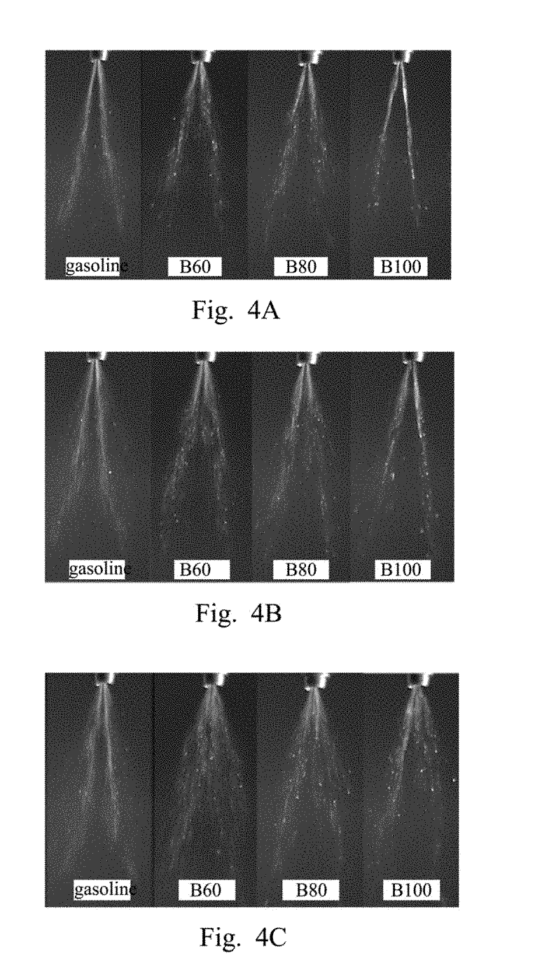

Next, the spraying state of the fuel is observed by an oil ejecting experiment. Please refer to FIGS. 4A˜4C. FIGS. 4A˜4C are photographs showing the atomization state of the fuel according to some embodiments of the present disclosure.

Please refer to FIG. 4A first, FIG. 4A is a photograph showing the spraying state of B100, B80, B60 and gasoline ejected from the injector while the pressure in the pipe is 2.5 kg/cm². It can be seen that B100, B80 and B60 ejected from the injector have bigger droplets than gasoline ejected from the injector, and hence the spraying degree decreases. Accordingly, 1-butanol may have a problem of spraying with higher concentration. Spraying is a process about liquid fuel divided into many small droplets, and hence the high viscosity of 1-butanol may affect the sizes of the fuel droplets and the flow rate of the fuel in the fuel applying system.

Next, increase the pressure of fuel to 3 kg/cm² and 3.5 kg/cm², and then observe the spraying state of the fuel ejected from the injector. As shown in FIGS. 4B and 4C, the spraying degrees of B100, B80 and B60 ejected from the injector while the pressure of fuel in the pipe is 3 kg/cm² or 3.5 kg/cm² are superior than those of B100, B80 and B60 ejected from the injector while the pressure of fuel in the pipe is 2.5 kg/cm². When the pressure of fuel in the pipe is 3.5 kg/cm², the spraying degrees of B100, B80 and B60 ejected from the injector are the best. It can be seen that the initial velocities of B100, B80 and B60 ejected from the injector become faster when the pressure of fuel in the pipe increases, and hence B100, B80 and B60 have more intensive friction phenomenon with air so as to divide the liquid fuel such as B100, B80 and B60 into much smaller droplets, which have better spraying degrees. Especially, the spraying degree of B100 has most obvious improvement.

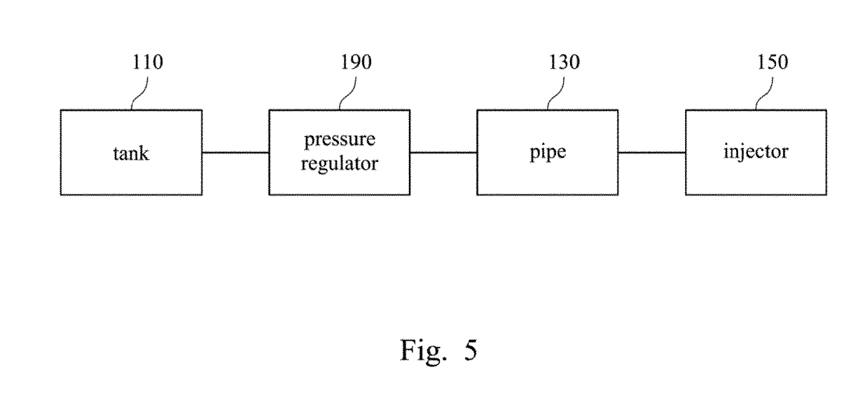

Please refer to FIG. 5. FIG. 5 is a schematic diagram illustrating a partial structure of the fuel applying system according to some embodiments of the present disclosure.

Therefore, in order to increase the spraying level of fuel to improve the problem of incomplete combustion, the method of applying fuel provided by the present disclosure further includes, other than providing a tank 110, an injector 150 and a pipe 130 between the tank 110 and the infector 150, providing a pressure regulator 190 between the tank 110 and the pipe 130. The pressure regulator 190 may control the pressure of the fuel in the pipe 130 so that the pressure of the fuel is in a range larger than 2.5 kg/cm² to 4.0 kg/cm², preferably in a range of 3.3 kg/cm² to 3.7 kg/cm², more preferably 3.5 kg/cm².

Then, the method of supplying fuel provided by the present disclosure is practically used in the motorcycle engine for the following tests. The motorcycle engine of the present disclosure is a four-stroke, 125-cc, single-cylinder port gasoline injection engine.

The results of an oil ejecting experiment can be seen that B100, B80 and B60 ejected from the injector have the best spraying degrees while the pressure of fuel in the pipe is 3.5 kg/cm². Accordingly, the experiments of engine using B100, B80 and B60 in the present disclosure are performed under the fuel pressure of 3.5 kg/cm². In an embodiment of the present disclosure, the experiments of engine using B100, B80 and B60 are performed under 4000 rpm wide open throttle (WOT) stoichiometric air-fuel ratio.

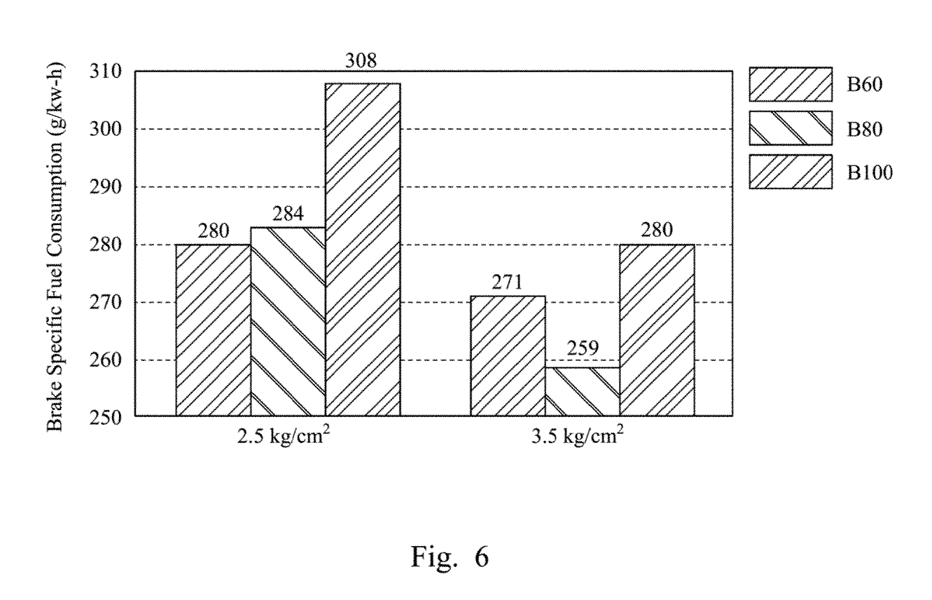

Please refer to FIG. 6. FIG. 6 is a data diagram illustrating the brake specific fuel consumption (BSFC) of an engine using B100, B80 and B60 according to some embodiments of the present disclosure.

As shown in FIG. 6, the BSFC of B100, B80 and B60 under 4000 rpm WOT stoichiometric air-fuel ratio while the pressure of fuel is 3.5 kg/cm² is lower than the BSFC of B100, B80 and B60 under 4000 rpm WOT stoichiometric air-fuel ratio while the pressure of fuel is 2.5 kg/cm². Since the performance of engine has good output, the BSFC decreases. BSFC may represent fuel consumption. The fuel consumption is less with the lower BSFC. In can be seen that the fuel consumption of engine is less when the pressure of fuel is 3.5 kg/cm².

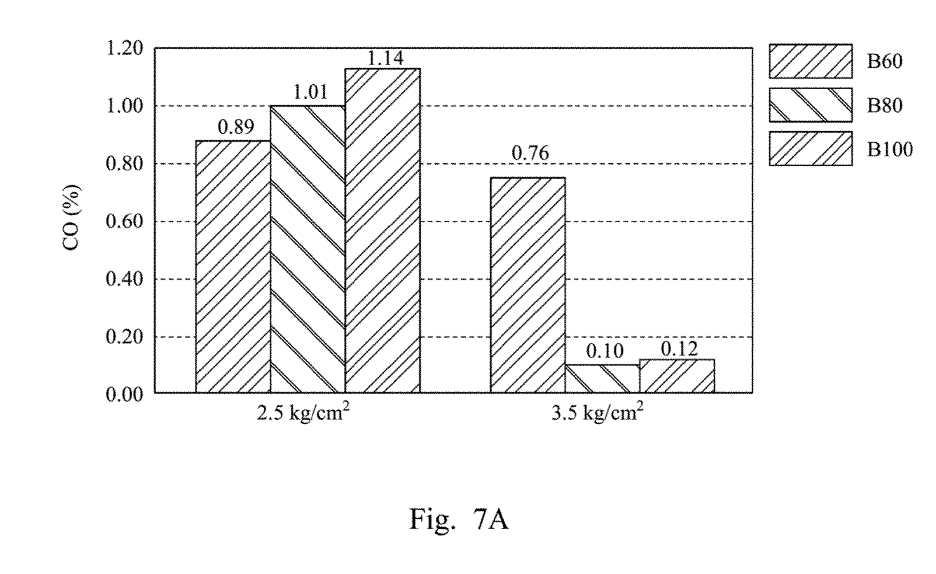

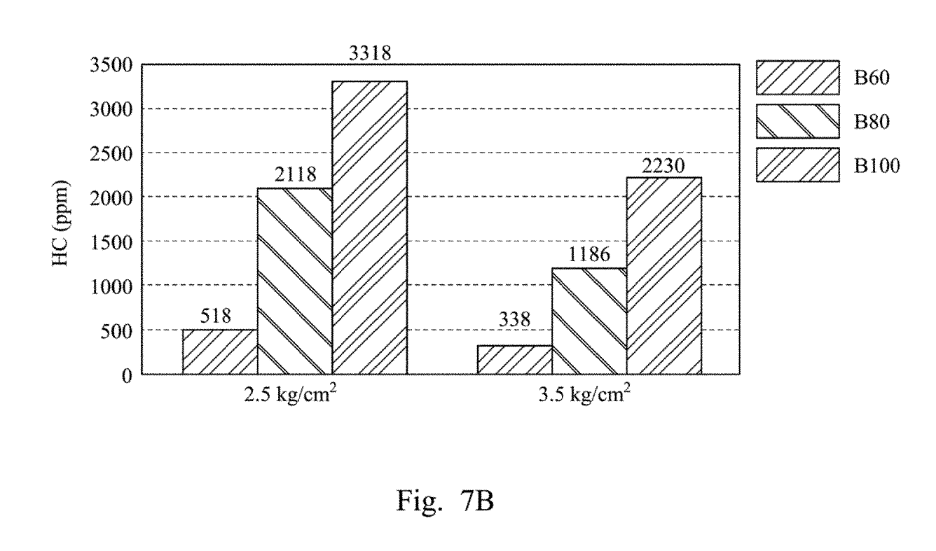

Continue to compare the amounts of the exhaust emitted by the combustion of the fuel under different pressure of the fuel. As shown in FIG. 7A, FIG. 7A illustrates the percentage of the amounts of carbon monoxide (CO) in the exhaust generated by the combustion of B100, B80 and B60 in the engine every 5 seconds on average. It can be seen that the amounts of CO generated by the combustion of B100, B80 and B60 while the pressure of fuel is 3.5 kg/cm² are less than the amounts of CO generated by the combustion of B100, B80 and B60 while the pressure of fuel is 2.5 kg/cm². Especially, the amounts of CO generated by the combustion of B100 and B80 dramatically decrease. Since the pressure of the fuel increases, the fuel combustion is more complete, and more oxygen atoms react with CO to form carbon dioxide (CO₂).

Please continue to refer to FIG. 7B. FIG. 7B illustrates the concentration (ppm) of hydrocarbon (HC) generated by the combustion of B100, B80 and B60 every 5 seconds on average. It can be seen that the concentration of HC generated by the combustion of B100, B80 and B60 while the pressure of fuel is 3.5 kg/cm² are less than those of HC generated by the combustion of B100, B80 and B60 while the pressure of fuel is 2.5 kg/cm².

The results shown in FIGS. 6, 7A and 7B can be seen that the fuel consumption of engine and the emitted amounts of CO and HC may decrease to achieve low fuel consumption and friendliness to environments when the pressure of fuel is 3.5 kg/cm².

Next, each sampling cycle of the cylinder pressure curve is observed by a combustion analyzer. The distribution of the maximum value of the cylinder pressure can be seen the variability of each cycle combustion. The cycle variability is smaller when the distribution of the maximum cylinder pressure is closer. While the distribution of the maximum cylinder pressure with large differences represents that the combustion is unstable, and it may induce incomplete combustion or cylinder pressure dramatically decreasing because of incomplete combustion. The cycle variability of engine usually uses coefficient of variation of indicated mean effective pressure (COV of IMEP) as an index. When COV of IMEP is lower, the stability of engine is better. The cycle variability of this embodiment is the indicated mean effective pressure of each cycle calculated by cylinder pressure with continuous 100 cycles.

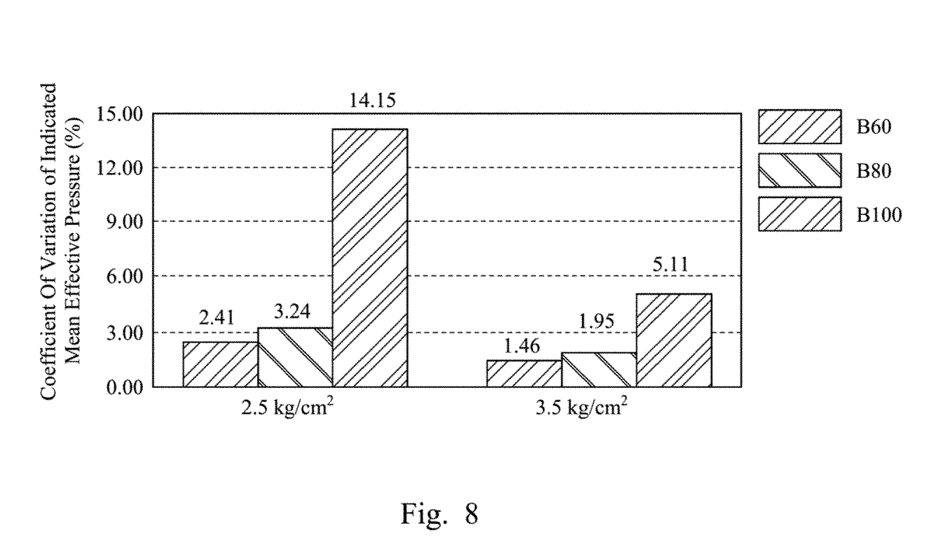

Please refer to FIG. 8. FIG. 8 is a data diagram illustrating the coefficient of variation of indicated mean effective pressure (COV of IMEP) of an engine according to some embodiments of the present disclosure. It can be seen that the COV of IMEP of B100, B80 and B60 used in the engine while the pressure of fuel is 3.5 kg/cm² is lower than the COV of IMEP of B100, B80 and B60 used in the engine while the pressure of fuel is 2.5 kg/cm². The lower the COV of IMEP, the more stable the engine.

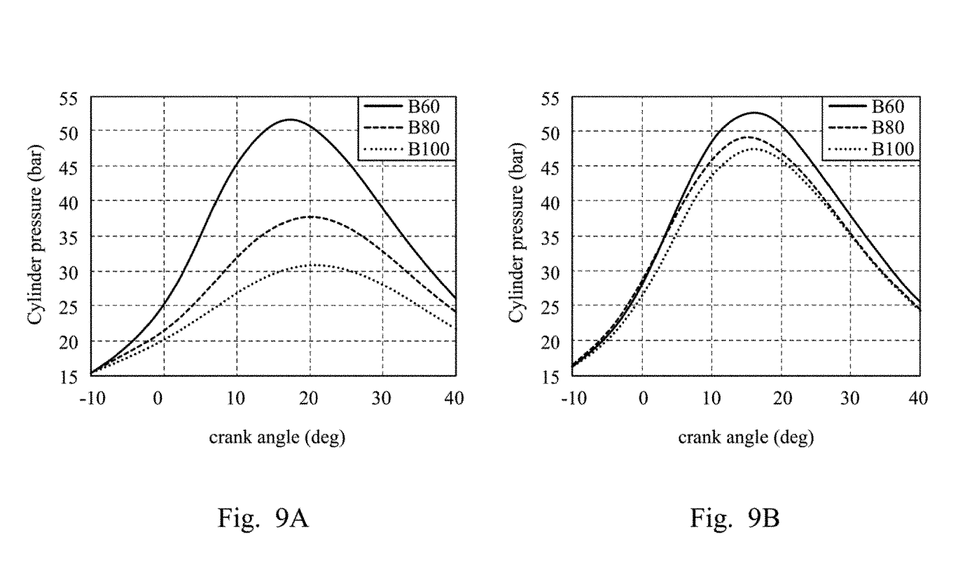

In addition, the analysis result of the cylinder pressure can determine its engine performance. Larger maximum value of the cylinder pressure represents better engine performance. As shown in FIGS. 9A and 9B, when engine is running at the fuel pressure of 2.5 kg/cm² (in FIG. 9A), once the butanol concentration of B100, B80 and B60 is higher, the maximum value of the cylinder pressure is lower. However, when the fuel pressure is 3.5 kg/cm² (in FIG. 9B), the maximum values of the cylinder pressure of B80 and B100 obviously increase, which can prove that increasing the fuel pressure to 3.5 kg/cm² enhances the performance of the engine using B100 and B80 as the fuel.

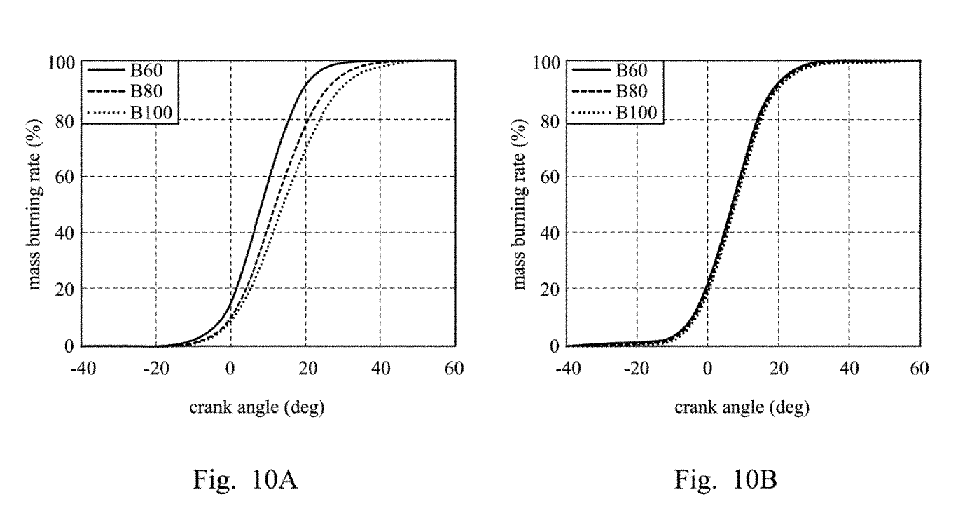

Continue to refer to FIGS. 10A and 10B. FIGS. 10A and 10B are data diagrams illustrating the mass burning rate of the fuel in the engine according to some embodiments of the present disclosure. CA50 represents the time of half combustion of the fuel, and the corresponding crank angle represents the stroke of the engine. As shown in FIGS. 10A and 10B, It can be seen that the corresponding crank angles of B100 and B80 at CA50 and the fuel pressure of 3.5 kg/cm² (in FIG. 10B) are smaller than those of B100 and B80 at CA50 and the fuel pressure of 2.5 kg/cm² (in FIG. 10A), which represents the increasing combustion rates of B100 and B80.

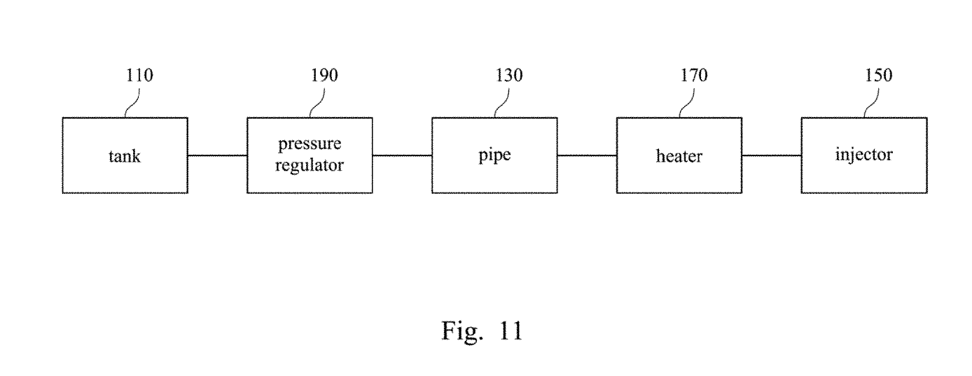

Please refer to FIG. 11. FIG. 11 is a schematic diagram illustrating a partial structure of the fuel applying system according to some embodiments of the present disclosure. It can be seen that increasing the fuel pressure and the temperature in the pipe of applying fuel system may enhance the spraying degree of the fuel to facilitate complete combustion of the fuel. Therefore, in accordance with some embodiments, the method of applying fuel provided by the present disclosure further includes, other than providing a tank 110, an injector 150 and a pipe 130 between the tank 110 and the injector 150, providing a pressure regulator 190 between the tank 110 and the pipe 130 as well as a heater 170 between the pipe 130 and the injector 150 so as to regulate the pressure and the temperature of the fuel in the pipe 130, which can control the fuel pressure in the pipe 130 in a range large than 2.5 kg/cm² to 4.0 kg/cm², preferably in a range of 3.3 kg/cm² to 3.7 kg/cm², more preferably at 3.5 kg/cm², and the fuel temperature in the pipe 130 in a range of 50° C. to 90° C., preferably in a range of 70° C. to 90° C.

The embodiments of the present disclosure discussed above have advantages over existing the method of supplying fuel for a motorcycle engine, and the advantages are summarized below. The method of applying fuel provided by the present disclosure may fully spray the fuel including butanol, facilitating the fuel to be evenly blended with air and burned completely, which enhances the performance and the stability of the engine and achieves low fuel consumption and friendliness to environments.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method of supplying fuel for a motorcycle engine, the method comprising:
providing a tank, a pipe and an injector, and the pipe between the tank and the injector;
transporting fuel in the tank to the pipe, and a pressure of the fuel in the pipe in a range larger than 2.5 and smaller than or equal to 4.0 kg/cm²;
performing a heat treatment to the fuel from the pipe; and
transporting the fuel to the injector.

2. The method of claim 1, wherein the pressure of the fuel in the pipe is controlled by a pressure regulator disposed between the tank and the pipe.

3. The method of claim 1, wherein the pressure of the fuel in the pipe is 3.5 kg/cm².

4. The method of claim 1, wherein the fuel is butanol or mixed oil comprising butanol and gasoline.

5. The method of claim 4, wherein the gasoline comprises octane number 95 unleaded gasoline.

6. The method of claim 4, wherein the percentage concentration by volume of the butanol in the mixed oil is in a range of 60˜99%.

7. The method of claim 4, wherein the percentage concentration by volume of the butanol in the mixed oil is in a range of 60˜80%.

8. The method of claim 4, wherein the percentage concentration by volume of the butanol in the mixed oil is 60%, and the percentage concentration by volume of the gasoline in the mixed oil is 40%.

9. The method of claim 4, wherein the percentage concentration by volume of the butanol in the mixed oil is 80%, and the percentage concentration by volume of the gasoline in the mixed oil is 20%.

10. The method of claim 1,
wherein after performing the heat treatment, a temperature of the fuel is in a range of 50˜90° C.

11. The method of claim 10, further comprising a heater disposed between the pipe and the injector, wherein the temperature of the fuel is controlled by the heater.

12. The method of claim 10, wherein the temperature of the fuel is in a range of 70˜90° C.
